(19) United States
(12) Patent Application Publication
(10) Pub. No.: US 2008/0057785 A1
(43) Pub. Date: Mar. 6, 2008

(54) USB copy-resistant plugging-and-locking device

(75) Inventor: Chien-Pi Huang, Taipei (TW)

Correspondence Address: TROXELL LAW OFFICE PLLC, SUITE 1404, 5205 LEESBURG PIKE, FALLS CHURCH, VA, 22041, US

(73) Assignees: Guann Tau International Corp.,; Jin Chyun Mei Enterprises Co., Ltd.

(21) Appl. No.: 11/790,291

(22) Filed: Apr. 24, 2007

(30) Foreign Application Priority Data
Apr. 26, 2006 (TW) 95207128

(51) Int. Cl. H01R 13/648

(52) U.S. Cl. 439/607

(57) ABSTRACT

A USB copy-resistant plugging-and-locking device having an end contacts a USB guided seat is capable of performing displacement movement along the extended direction of the USB guided seat. The USB guided seat has several guided slots, each of the guided slots provides a depth “d” at an end of the USB guided seat (3), and the several guided slots has at least a dimension specification. The USB copy-resistant plugging-and-locking device includes a housing for containing the USB guided seat and a plurality of alignment portions positioning on the housing and appearing as a predetermined arrangement. Each of the alignment portions is one-to-one correspondent to the several guided slots making the USB guided seat place into the containing space when the USB copy-resistant plugging-and-locking device performs a displacement movement along the extended direction of the USB guided seat.

### BACKGROUND OF THE INVENTION

1. Field of the Invention

The invention relates to a USB copy-resistant plugging-and-locking device, and more particularly, to a USB copy-resistant plugging-and-locking device that is capable of preventing the data from being stolen by adding a cipher code through the data transmission of USB port.

2. Description of the Prior Art

Science and technology change with each passing days. Following the popularization of the personal computer as well as the flourishing of the 3C-product, the peripherals having various specifications, components such as joints, plugging heads, and signal cables having different shapes and specifications, weed through the old and to bring forth the new. Ever since the issue of Windows 98 of the Micro-Soft Company, this new data transmission interfaces—the USB (Universal Serial Bus) has become a very hot issue.

In reality, the USB specification has gone to the public by Intel Company as early as 1996, but the operation system at that time did not support the driving function of this interface. The position of this new interface was not definite until the Windows 98 appeared to the market. USB is a specification of a general-purpose interface; it can connect to the peripherals such as the keyboard, the mouse, joystick etc. The connector of the keyboard in the past is a design of a circular one having six pins therein. The mouse has two different connectors having different specifications—a PS2 circular connector and a rectangular connector having 9 pins. This diversified design makes the users create a lot of trouble when it comes to implementing a computer or changing equipments. The function of the USB is to unify these diversified connectors.

The convenience of the USB relatively results in the seriousness of data let out. Anyone with a portable disc can plug in the USB port of the host computer to steal a copy of the data stored therein. Therefore, a locking device of USB port appeared on the market was developed.

FIG. 1 is an isometric exploded view of the structure of the locking device of a USB port of the prior art. As shown in FIG. 1, the locking device (1) of the USB port on the market of the prior art includes a moving head portion (11), a main body (12), a sliding switch (13), a connecting block (14) as well as two hooks (15). The sliding switch (13) positioned on the main body (12) can move on the first position (91) and the second position (92). The connecting block (14) secures at an end surface of the main body (12) and extends out of the end surface. The two hooks (15) inter-locked with the sliding switch (13) are positioned within the main body (12).

The hook portion (151) of the two hooks (15) is within the connecting block (14) when the sliding switch (13) positions at the first position (91). Therefore, the connecting block (14) can separate from the moving head portion (11), thus make the moving head portion (11) positions at the USB port (not shown in the Figure) to perform the locking of the USB port in order to prevent the data from being read. The hook portion (151) of the hook (15) will extends out of the connecting block (14) as the sliding switch (13) positions at the second position (92). Therefore, the connecting block (14) can connect to the moving head portion (11). By the use of the main body (12) to carry the moving head portion (11) out of the USB port, the USB port can be opened to use.

The above-mentioned locking device of USB port on the market of the prior art has the following demerits: the locking device (1) of a single USB port can perform separation from all the moving head portions (11); thereby, persons who purposely set his mind on doing something can open the moving head portion (11) by simply using a locking device (1) of the USB port to steal the whole data. Therefore, it has been an urgent plan and improvement project for the manufacturers to resolve the above-mentioned problems.

### SUMMARY OF THE INVENTION

In light of the above-mentioned demerits of the prior art, the invention provides a locking device of USB port that aims to ameliorate at least some of the demerits of the prior art or to provide a useful alternative.

The primary objective of the invention is to provide a USB copy-resistant plugging-and-locking device that makes use of a alignment portions furnished within the housing of the plugging-and-locking device, and guided slots corresponding to the alignment portions of the USB guided seat (3). Through the changes of the dimension and position of the alignment portions and the guided slots, the efficacy of the formation of cipher code generated by the USB copy-resistant plugging-and-locking device can be achieved.

The secondary objective of the invention is to provide a USB copy-resistant plugging-and-locking device to achieve the locking of the USB port for preventing the data from being stolen by the way that a plugging and locking device is capable of connecting to and separating from the USB port.

In order to achieve the above-mentioned objectives, the invention provides a USB copy-resistant plugging-and-locking device that has an end contacting a USB guided seat, and that is capable of performing displacement movement along the extended direction of the USB guided seat. The USB guided seat has several guided slots, each of the guided slots provides a depth “d” at an end of the USB guided seat, and the several guided slots has at least a dimension specification. The USB copy-resistant plugging-and-locking device includes a housing for containing the USB guided seat, and a plurality of alignment portions positioning on the housing and appearing as a predetermined arrangement. Each of the alignment portions is one-to-one correspondent to the several guided slots making the USB guided seat place into the containing space when the USB copy-resistant plugging-and-locking device performs a displacement movement along the extended direction of the USB guided seat.

The accomplishment of this and other objectives of the invention will become apparent from the following description and its accompanying drawings of which:

### BRIEF DESCRIPTION OF THE DRAWINGS

FIG. 1 is an isometric exploded view of the structure of the locking device of a USB port of the prior art;

FIG. 2 is an isometric exploded view of the USB copy-resistant plugging-and-locking device of the preferred embodiment of the invention;

FIG. 3A is a schematic bottom view of the plug of the USB copy-resistant plugging-and-locking device of the first embodiment of the invention;

FIG. 3B is a schematic side view of the plug of the USB copy-resistant plugging-and-locking device of the first embodiment of the invention;

FIG. 3C is a schematic bottom view of the plug of the USB copy-resistant plugging-and-locking device of the second embodiment of the invention;

FIG. 4A is a schematic bottom view of the guided seat of the USB copy-resistant plugging-and-locking device of the first embodiment of the invention;

FIG. 4B is a schematic bottom view of the guided seat of the USB copy-resistant plugging-and-locking device of the second embodiment of the invention;

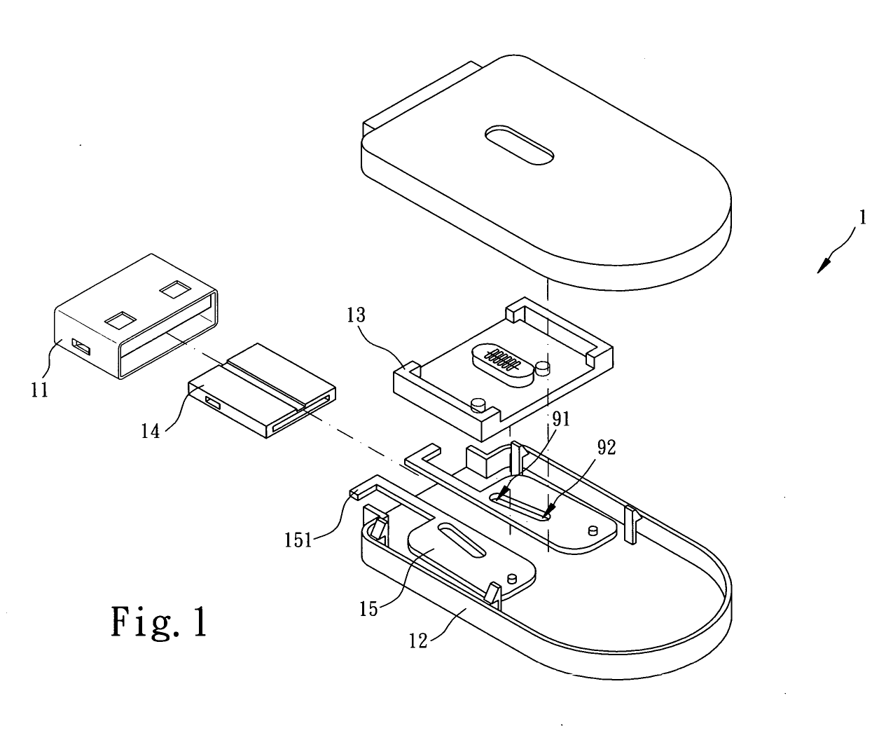

### DETAILED DESCRIPTION OF THE PREFERRED EMBODIMENT

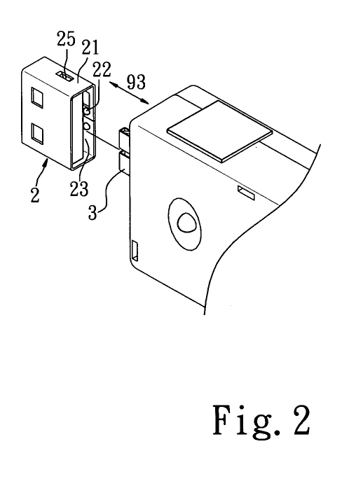

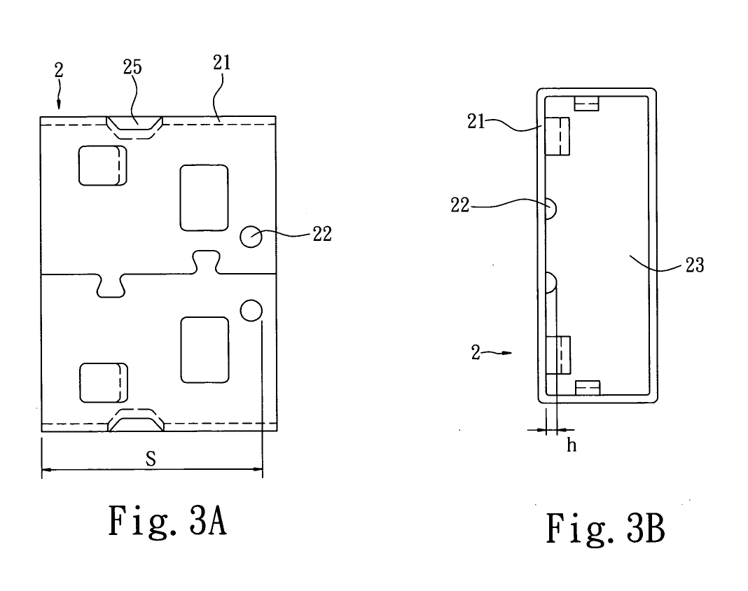

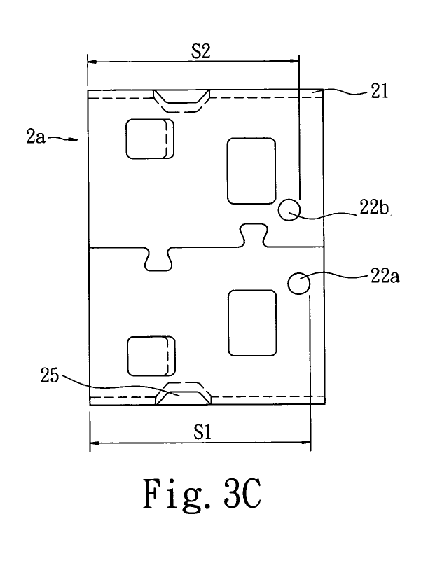

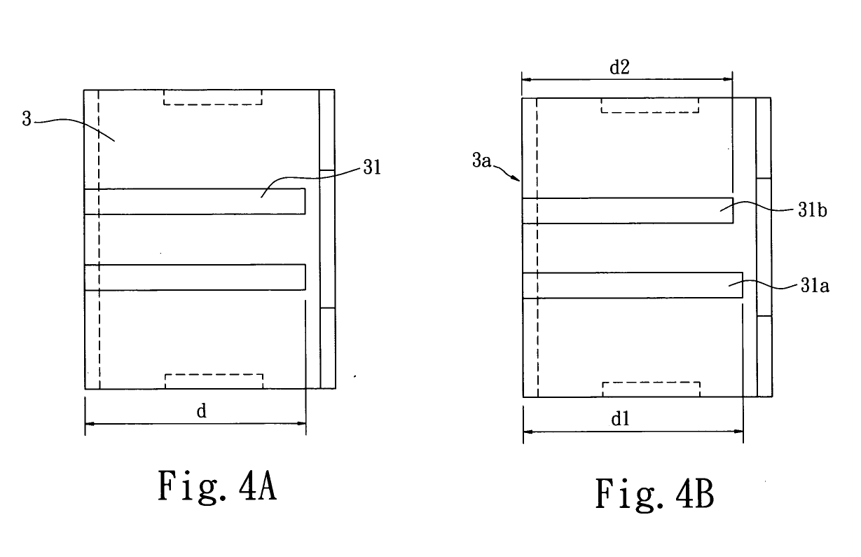

FIG. 2 through FIG. 4A are isometric exploded views of the structure of the USB copy-resistant plugging-and-locking device of the invention. As shown in FIG. 2 through FIG. 4A, an end of the USB copy-resistant plugging-and-locking device (2) can contact a USB guided seat (3) and perform displacement movement along the extended direction (93) thereof, where the USB guided seat (3) possesses several guided slots (31). The USB copy-resistant plugging-and-locking device of the invention includes a housing (21) and a plurality of alignment portions (22). The housing (21) has a containing space (23) for containing the USB guided seat (3) while the plurality of alignment portions (22) are positioned on the housing (21) and having a height “h” extended along the direction of the containing space (23).

In the first embodiment of the invention, the plurality of alignment portions (22) are designed as two thereof, and each of the alignment portions (22) keeps a same distance “s” from an end of the housing (21) while several guided slots (31) are also designed as two thereof, and are one-to-one correspondent to the positions of the alignment portions (22). Each of the guided slots (31) provides a depth “d” at an end of the USB guiding seat (3). The dimension of the distance “s” is set not to be greater than the dimension of the depth “d” for facilitating the placing of the USB guided seat (3) into the containing space (23) when the USB copy-resistant plugging and locking device (2) performs displacement movement along the extended direction (93) of the USB guided seat (3). In other words, the USB guided seat (3) is unable to place the USB guided seat (3) completely into to the containing space (23) if the dimension of the distance “s” is greater than the dimension of the depth In the second embodiment of the invention, the plurality of alignment portions (22a)-(22b) are designed as two thereof, and each of the alignment portions (22a)-(22b) keeps a different distance “s1”-“s2” respectively from an end of the housing (21) while the guided slots (31a)-(31b) of the USB guided seat (3a) are accordingly designed as two thereof, and the depths “d1”-“d2” provided at the ends of each of the guided slots (31a)-(31b) are different. However, each of the guided slots (31a)-(31b) is one-to-one correspondent to the positions and distance “s1”-“s2” of the alignment portions (22), thereby, it is capable of completely placing the USB guided seat (3a) into the containing space (23). Due to the variation of the position and dimension of the alignment portions (22a)-(22b) and the guided slots (31a)-(31b), it is understood that not all the USB guided seat (3a) can be completely placed in the containing space (23), and it is for this reason that the USB copy-resistant plugging and locking device (2) of the invention possesses the efficacy of having cipher codes. Certainly, the alignment portions (22) and the guided slots (31) can also be designed as three or more thereof, and it is for these variations that make the invention have even more cipher efficacies.

In the preferred embodiment of the invention, each side of the housing (21) has an open channel (25), and the USB guided seat (3) has the corresponding two hook portions (32) that are capable of connecting to the open channels (25) making the housing (21) combine with the USB guided seat (3) to form an integral body.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A USB copy-resistant plugging-and-locking device having an end contact a USB guided seat and perform displacement movement along the extended direction of the USB guided seat that has several guided slots, and each of which provides a depth “d” at an end therefrom, and the several guided slots have at least a dimension specification, comprising:
a housing having a containing space for containing the USB guided seat; and
a plurality of alignment portions positioning on the housing and appearing as a predetermined arrangement;
wherein, each of the alignment portions is one-to-one correspondent to the several guided slots making the USB guided seat place into the containing space when the USB copy-resistant plugging-and-locking device performs a displacement movement along the extended direction of the USB guided seat.

2. The USB copy-resistant plugging-and-locking device as claimed in claim 1, wherein the alignment portions extend a height “h” along the direction of the containing space.

3. The USB copy-resistant plugging-and-locking device as claimed in claim 1, wherein the alignment portions keep a distance “s”, and the dimension of the distance “s” is set not to be greater than the dimension of the depth “d”.

4. The USB copy-resistant plugging-and-locking device as claimed in claim 1, wherein each side of the housing has an open channel, and the USB guided seat has the corresponding two hook portions that are capable of connecting to the open channels making the housing combine with the USB guided seat to form an integral body.
